(19) United States
(12) Patent Application Publication
(10) Pub. No.: US 2005/0075772 A1
(43) Pub. Date: Apr. 7, 2005

(54) Utilizing bullets to safely prevent the turnover of a speeding car caused by a punctured front tire

(76) Inventor: Young Ill Choi, Burbank, CA (US)

Correspondence Address: Eugene Oak, Ph.D., J.D.;Patent Attorney, 610 S. Van Ness Ave., Los Angeles, CA, 90005, US

(21) Appl. No.: 10/678,914

(22) Filed: Oct. 6, 2003

(51) Int. Cl. G06F 7/00

(52) U.S. Cl. 701/45

(57) ABSTRACT

To quickly and safely prevent the overturn of a car caused by a punctured front tire of a speeding car, four sets of one bullet located inside a short barrel are installed into the covers of both rear wheels. A computer program is loaded into the central computer of the car to actuate the trigger of the bullet in order to puncture both rear tires. Manual switches on the lever handle of the car may override the computer to actuate the trigger.

### FIELD OF THE INVENTION

This invention is related to the emergency stopping method of a speeding car from overturning because of a punctured front tire.

### BACKGROUND OF THE INVENTION

When the front tire of a speeding car is punctured, the car's driver instinctively puts pressure onto the brake pedal. The car is then easily turned over due to the momentum of the direction headed as the anterior of the car drops. The driver and passengers of the car may suffer from severe heart conditions due to the shock and jolts of the moment. The best way to decrease the speed of a tire-punctured car is to concurrently lower and add a drag force to the posterior of the car. Unfortunately, the computer controlled brake systems these days do not lower down the car's posterior far enough. Therefore, the sudden unbalance of the vehicle cannot immediately be stopped with the use of any brake systems that exist today. The purpose of this invention is to provide an immediate drag force and to lower the posterior tires in order to stop the car without turnover. Part of activating this mechanism utilizes the computer controlled wheel balance system of prior arts.

### DESCRIPTION OF PRIOR ARTS

U.S. Pat. No. 2,687,191 to Shannon and U.S. Pat. No. 2,710,074 to Simpson both illustrate an emergency brake system for large vehicles. They keep to the ground by a compressed air force and a spring force, respectively.

U.S. Pat. No. 4,265,338 to Shea, et al. illustrates an emergency brake system that utilizes an elongated flexible skid member held within a tray-like support above the vehicle's wheels.

U.S. Pat. No. 4,133,414 to Ushitani illustrates a subsidiary ski type disc brake provided between the rear wheels.

U.S. Pat. No. 5,439,076 to Percy, Jr. illustrates an emergency brake device for stopping the rear wheels of a vehicle comprising a wedge assembly that includes a frame and a resilient wedge carried by an operable frame secured to the underside of the vehicle. U.S. Pat. No. 5,497,857 Warren, et al. illustrates an emergency brake system that includes a deformable brake wedge for each tire on one of the vehicle's axles.

U.S. Pat. No. 6,401,876 to Boros illustrates a ground-engaging emergency brake and anti-jackknife system for a vehicle that comprises a brake skid which has at least one substantially elongated upper and lower planar rigid base members. Other types of emergency brake systems are controlled with loads to each wheel.

Whatever type the emergency brake may be, none of the prior arts illustrate an emergency brake system that renders an additional drag force to the posterior wheels and lowers the level of the posterior in order to prevent the turnover of a car caused by a punctured front tire.

### SUMMARY OF THE INVENTION

The purpose of this invention is to provide a safe emergency brake to a speeding vehicle caused by the puncture of a front tire without flipping over. Four sets of one bullet located in a short barrel are installed inside both posterior wheel covers. Each rear wheel cover is equipped with two sets of bullets in a barrel facing the lower part of rear wheel tire. A switch activated by the main computer of the car connects electricity to the trigger of the spring and punctures the both anterior tires. A manual overriding switch on the lever handle of the car may override the trigger line. This emergency brake system operates only when the car runs over 100 km/hr. Right after the rear tires are punctured, the posterior height of the car is lowered to prevent the car from flipping over.

### BRIEF DESCRIPTION OF THE DRAWINGS

FIG. 1 is a schematic drawing of balanced force when a speeding car has a punctured front wheel.

FIG. 2 is a schematic drawing of an emergency break system that punctures anterior tires using bullet.

FIG. 3 is a schematic front view of the emergency break system puncturing the posterior tires using bullets seen from the front of a car.

FIG. 4 is a logical diagram of this emergency break system stored in the main computer of the car.

FIG. 5 is a manual-overriding switch that is installed onto the lever handle of the car.

### DETAILED DESCRIPTION OF THE PREFERRED EMBODIMENT

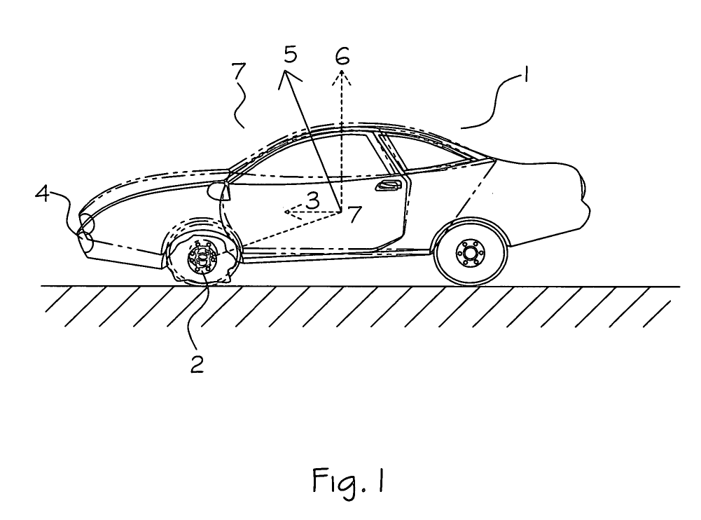

FIG. 1 is a schematic drawing of a balanced force when a speeding car (1) has been punctured at a front wheel (2). When a car (1) runs at high speed in normal condition, the forward momentum (3) caused by the propelling power of the car results in the anterior of the car to become parallel to the ground. When the car is speeding over 100 km/hr (65 miles/hr) as it receives a puncture in the front tire, the anterior (4) of the car collapses down. Most drivers reflexively put pressure on the brake pedal when they hear the sound of a tire being punctured. At that moment, the punctured and lowered front wheel (2) acts as a pivot point of rotating momentum (5), which is the vector summation of the forward (3) and lifting momentum (6), brought on by the collapsing of the car's anterior (4). The point (7) is the center weight of the car.

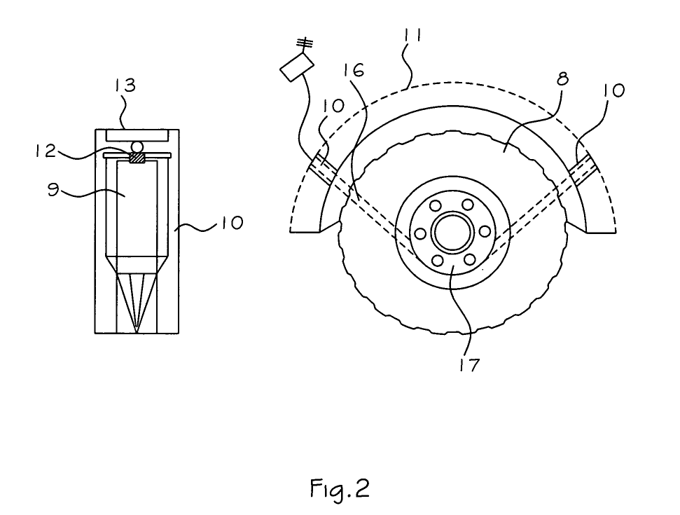

FIG. 2 is a schematic drawing of an emergency brake system puncturing the posterior tires (8) with bullets (9). Two sets of one bullet (9) located in a short barrel (10) are installed inside one posterior wheel cover (11). Another two sets of bullet (10) in a short barrel (11) are installed inside the other posterior wheel cover. The percussion (12) of the bullet (9) is connected to an electric trigger line (13). The electric trigger line is connected the central control computer of the car (not shown in this invention) for supplying electricity to the percussion (12) of the bullet (9) at the proper time.

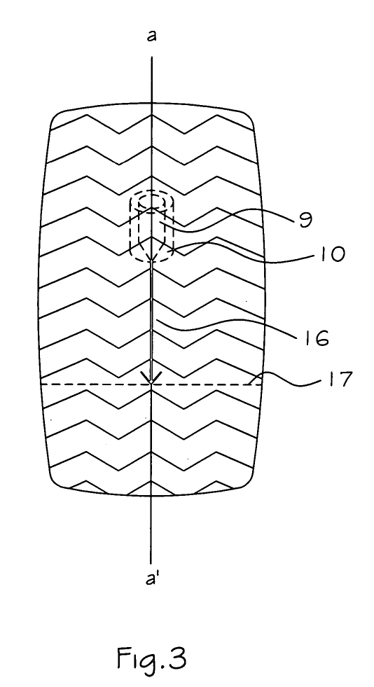

FIG. 3 is a schematic front view of an emergency brake system puncturing rear tires (8) with bullets (9) seen from the anterior of the car. The bullet (9) located in a barrel (10) aims at the centerline a-a′ of the rear tire (15). The trajectory line (16) of the bullet (9) will meet the lower part of the rear wheel (17).

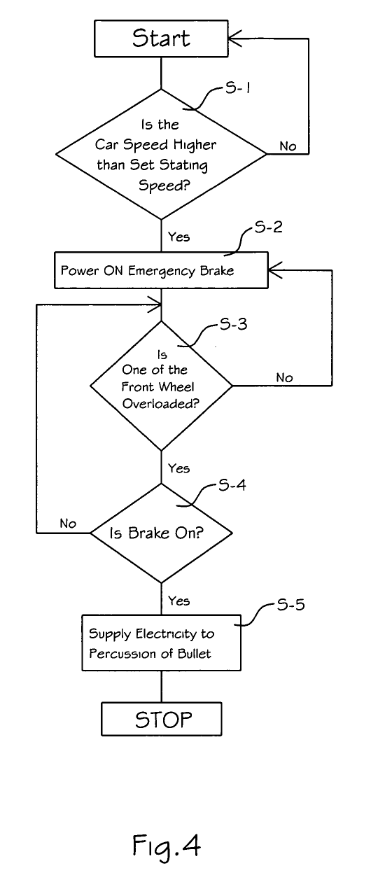

FIG. 4 is a logical diagram of this emergency brake system stored in the car's main computer. When the speed of the car exceeds 100 km/hr, the system becomes operational. The driver can adjust the starting speed. In step S-1, the computer compares the speed of the car with the set starting speed. If the speed of the car is lower than the set starting speed, then return to the “START” step. If the speed of the car exceeds the set starting speed, the emergency brake system turns on in step S-2. A lamp on the driving gauge reads “EMERGENCY BRAKE SYSTEM ON” in blue light. In step S-3, the computer of the car checks the load to the each wheel. When one of the front tires suffers from a severe load means that the tire is punctured. Check if the driver put pressure on the brake pedal in step S-4. If the driver did not put the pressure on the brake pedal, return to step S-3 and check if the overload state remains. If the driver put pressure on the brake pedal, then supply electricity to the percussion (12) of the bullet (9).

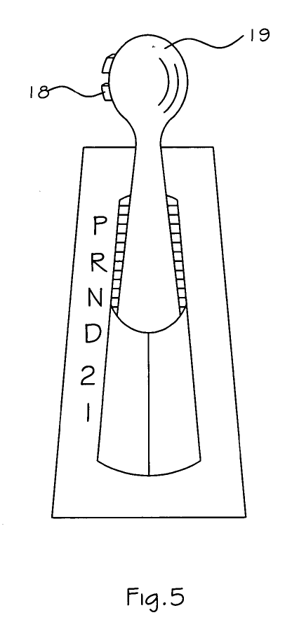

FIG. 5 is a manual-overriding switch (19) installed onto the lever handle (20) of the car. This manual-overriding switch (19) on the lever (20) of the car may override the trigger line.

1. To stop a car speeding over 100 km/hr with a punctures front tire, one can utilize an emergency brake system that punctures the posterior tires with four sets of one bullet, where the percussion is connected to the car's main computer. Electricity is supplied to the percussion in order to puncture the anterior tires by shooting the bullet towards the anterior tires when only one of the front wheels is over loaded and the brake pedal is in operational mode. Located in a short barrel, two sets are installed inside each rear wheel cover.

2. To stop a car speeding over 100 km/hr with a punctures front tire, one can utilize an emergency brake system that punctures the posterior tires with four sets of one bullet, where the percussion is connected to an electric trigger line connected to a manual trigger switch that supplies electricity to the percussion in order to shoot the bullet to puncture the rear wheel tires. Located in a short barrel, two sets are installed inside each rear wheel cover.
